(19) United States
(12) Patent Application Publication
(10) Pub. No.: US 2008/0151828 A1
(43) Pub. Date: Jun. 26, 2008

(54) Method, Mobile Station and Base Station System for Transmitting Data Packets in a Packet Data Communication System

(75) Inventors: Peter Bjorken, Solna (SE); Andreas Olsson, Stockholm (SE); Erik Westerberg, Enskede (SE)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 11/913,030

(22) PCT Filed: Apr. 29, 2005
(86) PCT No.: PCT/SE05/00624

§ 371 Date: Oct. 29, 2007

(51) Int. Cl. H04Q 7/00

(52) U.S. Cl. 370/329

(57) ABSTRACT

The object of the present invention is to provide a solution wherein data packets can be transmitted in a mobile packet data communication system between a mobile station (500) and a base station system (510) over an air interface (520) with a short initial access time delay, without unnecessary consumption of system resources and the mobile station's battery resources. This is achieved by using a novel channel type called non-scheduled traffic channel for transmitting data packets between a mobile station and a base station system. The non-scheduled traffic channel is accessible to a selected number of the mobile stations residing in a cell. The non-scheduled traffic channel is used such that a data packet is transmitted from the mobile station (500) to the base station system (510) or from the base station system (510) to the mobile station (500) over the non-scheduled traffic channel without any connection being established between the mobile station and the base station system before the data packet is transmitted and without the non-scheduled traffic channel being scheduled for the transmission before the data packet is transmitted. An identifier would be appended to the data packet such that the mobile stations in the cell would know to which mobile station the packet is addressed, in case of downlink transmission, and such that the base station system would know from which mobile station the data packet was transmitted, in case of uplink transmission.

### FIELD OF THE INVENTION

The present invention relates to methods, mobile stations and base station systems for transmitting data packets in a packet data communication system, and more particularly it relates to a method, a mobile station and a base station system for enabling fast access to a radio channel for transmitting data packets without inefficient utilization of transmission resources and without high battery consumption in the mobile station.

### BACKGROUND OF THE INVENTION

In a mobile packet data communication system, data packets are transmitted over a radio channel in the air interface between a mobile station and a base station system. Such a mobile packet data communication system may be based on e.g. Time Division Multiple Access (TDMA) or Code Division Multiple Access (CDMA). In a TDMA-based system, such as Enhanced Data rates for Global Evolution (EDGE), which is an improvement of the radio interface of General Packet Radio Services system (GPRS), and described for example in the 3GPP TS 44.018 and 44.060, each frequency is divided into a number of periodically recurrent time slots, wherein each periodically recurrent time slot defines a radio transmission channel. Each radio channel can be used for sending circuit switched and packet switched data. A radio channel is used by a logical channel for transmitting either traffic data or control data. A logical channel is a channel used for transmitting data belonging to a certain data flow between a base station system and a certain mobile station. In a GPRS/EDGE based system there is at least one radio channel in a cell used as a logical control channel for controlling packet switched data transfers and circuit switched data transfers. A radio channel used for transmitting packet data, a packet data channel (PDCH), may be used by a number of mobile terminals simultaneously. A base station system comprises a base transceiver station and a base station controller.

When a data packet is about to be transmitted from e.g. a mobile station to a base station system in a mobile packet data communication system, a connection is set up or established between the mobile station and the base station system. When a connection is being set up according to prior art methods, a radio channel is assigned for the transmission before any data packet can be transmitted over the connection. Also, a connection may use more than one radio channel for a data transmission, i.e. for transmitting data packets belonging to the same data flow. To establish a connection involves to reserve a radio channel(s) by the base station system, and to inform the mobile station of the reserved radio channel, in e.g. an assignment message. When the mobile station has received the assignment message the connection between the mobile station and the base station system is established over the assigned radio channel. In GPRS/EDGE this connection is called a temporary block flow (TBF). One TBF is established for uplink transmission (i.e. from the mobile station to the base station), and/or another TBF is established for downlink transmission, depending on in which direction data is to be sent. When the TBF has been established, data packets can be transmitted over the established connection. The TBF can be used for transmitting consecutive data packets to/from the same mobile station. When the data transmission is completed, the TBF will be released. It is also possible to keep the established TBF a certain time after the data transmission is completed, to cater for the possibility of transmitting new incoming data packets over the connection. According to the prior art above, the base station system schedules the reserved radio channel for the transmission of data for an established TBF. To schedule a radio channel for a data transmission means to decide over which radio channel data is to be transmitted for an established TBF and when a data packet is to be transmitted over the radio channel. As shown, when transmitting data from a mobile station that has no connection to the mobile network, a connection is established, data packets are transmitted over the radio channel(s) scheduled in the connection and the connection is released when the data packets have been transmitted.

According to GPRS/EDGE, a mobile station may be in different modes depending on if it is currently used for transmission or not. When the mobile station is in idle mode, it does not communicate with the network. The only contact the mobile station has with the network is to listen to a logical control channel (the common control channel). Thereby, the mobile station and its whereabouts is not known to the network. Consequently, no connection is setup between the mobile station and the base station system, i.e. no TBF is established, and consequently no radio channel is scheduled for the transmission between the mobile station and the base station system. When the mobile station is in active mode, a connection is set-up between the mobile station and the base station system, i.e. a TBF is established, and a radio channel is scheduled for the transmission.

FIG. 1 shows an example of a procedure for transmitting data packets from a mobile station being in idle mode to a base station, i.e. in an uplink direction, in a GPRS/EDGE based system according to the 3GPP TS 44.018 and 44.060. When the mobile station is in idle mode a connection has to be established to the base station system and a radio channel has to be scheduled before data can be transmitted.

A data packet arrives 101 at a transmission buffer in the mobile station 100. The mobile station then has to wait a random time, typically between 0-200 ms, until it can get access to a Random Access Channel (RACH). The RACH is a logical control channel that can be used by all mobile station in a cell to request a radio channel for transmission of data. When the mobile station (MS) gets access to the RACH it sends a channel request message 102 on the RACH to the base station 110. The base station responds by assigning a packet data channel to be used for the transmission, wherein the packet data channel is a channel that can be used for transmitting data traffic, i.e. data packets, and by sending an immediate assignment message 103 on a logical control channel called the Access Grant Channel (AGCH), informing the mobile station of the assigned channel. The assignment message comprises a Temporary Flow Identity (TFI), which is used to identify the TBF when it is transmitted over the radio channel, and an Uplink State Flag (USF) that is allocated to the mobile station for later use in scheduling the mobile station on the assigned channel. The assignment message also includes a Timing Advance value, which is calculated based on the channel request message. When receiving the assignment message, an uplink TBF is set up between the mobile station and the base station system and the mobile station will go into active mode. As mentioned above, the USF is used to inform the MS when to transmit a data packet, i.e. when the mobile station is scheduled to transmit a data packet over the assigned radio channel. When the mobile station receives a first USF 104a, the first data packet will be transmitted 105a to the base station. Following data packets will be transmitted consecutively 105b-n, each data packet after receiving a USF 104b-n.

FIG. 2 shows an example of a procedure for transmitting data packets from a base station system to a mobile station being in idle mode, in a GPRS/EDGE based system according to the 3GPP TS 44.018 and 44.060. In this example, the mobile station in idle mode is also in Discontinuous Reception mode (DRX mode). To be in DRX mode means that the mobile station only listens for messages on the control channel once in a period called a Paging cycle, which for example could be 2 seconds, but which depends on the implementation.

The base station system (BSS) 110 receives a data packet in its transmission buffer 201. Since the mobile station is in a DRX mode, the BSS has to wait a random time, which may be anything between 0 seconds to the paging cycle period, e.g. 2 seconds, before it can transmit an assignment message 202 to the mobile station 100. The assignment message is used to set up a connection (TBF), as described in FIG. 1. Thereafter, the BSS 110 may send a packet polling request 203 to the MS 100, and the mobile station replies with a packet control acknowledgement message 204. The packet polling request and the packet control acknowledgement message is used to calculate the timing advance value. Thereafter, the BSS sends a packet downlink assignment message 205, including the Timing Advance value to the MS, and then the first data packet is transmitted 206a over the assigned channel as a Radio Block to the MS. Following radio blocks will be transmitted 206b-n on following assigned time slots.

When the mobile station is in idle mode it consumes no system resources, since no connection to the network is established and no channel is assigned. Also, as mentioned above, when the mobile station is in DRX mode it uses a sleep mode procedure, wherein the MS only wakes up to listen to the control channel once in a paging cycle. Thereby, the battery power of the mobile station is saved. Although, a drawback is that there would be a certain delay from when the first data packet is received in the buffer of the mobile station or in the buffer of the base station system until the first data packet can be transmitted. Especially there would be a long buffering time for data packets to be transmitted in downlink direction when the mobile station is in DRX mode.

FIG. 3 shows an example of a procedure for transmitting data packets from a mobile station being in active mode to a base station, in a GPRS/EDGE based system according to the 3GPP TS 44.060.

When the mobile station is in active mode, a logical connection (TBF) has already been established, and at least one packet data channel (PDCH) has been scheduled, on which the base station system periodically sends USFs 301a-n informing the mobile station about the next opportunity to send a data packet, e.g. as a radio block (see also FIG. 1). As long as the mobile station has data packets to send, it will transmit 302a-n a radio block including a data packet after receiving each USF. If, at one sending opportunity 303, the MS has no data packet to send, it may do nothing, as shown in FIG. 3, it may send a dummy block over the radio channel or it may send old radio blocks. When the next data packet is received 304 in the buffer of the mobile station, the MS will transmit 302k this data packet as a radio block to the BSS over the packet data channel as soon as the MS receives 301k the next USF from the BSS. If the MS has had no data packets to send for a certain time period, the connection (TBF) will be released and the mobile station will go into idle mode.

FIG. 4 shows an example of a procedure for transmitting data packets from a base station system to a mobile station being in active mode, in a GPRS/EDGE based system according to the 3GPP TS 44.060.

When a data packet arrives 401 at the buffer of the BSS, the BSS would transmit 402a the data packet as a radio block at the next scheduled time slot of the packet data channel already allocated in the established TBF. Following data packets will be transmitted 402b-n at following time slots.

As described, in the active mode shown in FIGS. 3 and 4, the mobile station already has a connection (TBF) established with the base station system, and a radio channel is scheduled for the communication. Since no set-up is necessary, the access time, i.e. the time from receiving a packet in the buffer until the packet is sent can be very short, as low as 20 ms. But since a radio channel is scheduled to the mobile station when it is in active mode, system resources are used also when no data traffic is transmitted. Since the radio channels are limited in a cell, only a small fraction of all mobile stations in the cell can be kept in active mode at the same time.

A system using the prior art active mode and idle mode as shown above would be sufficient for a case where the majority of the traffic in a cell can tolerate an initial time delay of e.g. 500 ms when transmitting a data packet belonging to a new data flow. This is the case when the majority of the mobile data communication applications are web browsing and messaging, e.g. MMS and e-mail. Although, in the future it is presumed that mobile data communication applications will to a greater deal be access time sensitive traffic like push to talk and voice over IP. In such a scenario, a system using the prior art modes for transmitting data packets will not be able to support the large volumes of access time sensitive traffic in an acceptable manner. Therefore, there is a need for a solution wherein data packets can be transmitted with a short initial access time delay, without unnecessary consumption of system resources and the mobile station's battery resources. I.e. there is a need for a solution for transmitting data packets with a short initial time delay from or to a mobile station being in an idle mode.

### SUMMARY OF THE INVENTION

An object of the present invention is to provide a solution for transmitting data packets with a short initial time delay from or to a mobile station being in an idle mode.

The above object is achieved by a method, a mobile station, a base station system and a computer program product set forth in the independent claims.

The above object is achieved by using a novel channel type called non-scheduled traffic channel for transmitting data packets over the air interface between a mobile station and a base station system. The non-scheduled traffic channel is used such that a data packet is transmitted from the mobile station to the base station system or from the base station system to the mobile station over the non-scheduled traffic channel without any connection being established between the mobile station and the base station system before the data packet is transmitted and without the non-scheduled traffic channel being scheduled for the transmission before the data packet is transmitted.

In case of uplink transmission, for the base station system to know from which mobile station the data packet was transmitted, an identifier of the transmitting mobile station is appended to the data packet. Similarly, in case of downlink transmission, for receiving mobile stations to know to which mobile station the data packet is destined, an identifier of the destined mobile station is appended to the data packet.

According to a first aspect of the invention, a method is provided for transmitting data packets from a mobile station to a base station system in a mobile packet data communication system, wherein the mobile station is in an area within radio communication distance of the base station system. The method comprising the steps of:
receiving a first data packet in a transmission buffer of the mobile station and
transmitting the first data packet from the mobile station over a non-scheduled traffic channel to the base station system.

The non-scheduled traffic channel is accessible for transmission of data packets to/from a selected number of mobile stations residing in an area within radio communication distance of the base station system, and the mobile station is included in the selected number of mobile stations. The first data packet is transmitted from the mobile station over the non-scheduled traffic channel without any connection being established between the mobile station and the base station system before the first data packet is transmitted and without the non-scheduled traffic channel being scheduled for the transmission before the first data packet is transmitted.

According to a second aspect of the invention, a method is provided for transmitting data packets from a base station system to a mobile station in a mobile packet data communication system, wherein the mobile station is in an area within radio communication distance of the base station system. The method comprises the steps of:
receiving a first data packet in a transmission buffer of the base station system, and
transmitting the first data packet from the base station system over a non-scheduled traffic channel to the mobile station.

The non-scheduled traffic channel is accessible for transmission of data packets to/from a selected number of mobile stations residing in an area within radio communication distance of the base station system, and the mobile station is included in the selected number of mobile stations. The first data packet is transmitted from the base station system over the non-scheduled traffic channel without any connection being established between the mobile station and the base station system before the first data packet is transmitted and without the non-scheduled traffic channel being scheduled for the transmission before the first data packet is transmitted.

An advantage of the invention is that the access time, i.e. the time from receiving a data packet in a transmission buffer until the data packet is transmitted over an air interface is shortened compared to the prior art case when the mobile station is in idle mode.

A further advantage is that the access time can be shortened without unnecessary usage of system resources for keeping a connection established and for reserving a channel for a transmission.

A still further advantage is that a mobile communication system using a mixture of regular packet data channels, regular common control channels and non-scheduled traffic channels according to the invention for transmitting data over the air interface will be able to support the transmission of large volumes of access time sensitive traffic in such a system.

An advantage with an embodiment of the invention wherein the mobile station is in a discontinuous reception mode when the first data packet is transmitted to or from the mobile station is that the battery life time of the mobile station can be extended compared to prior art.

### BRIEF DESCRIPTION OF THE DRAWINGS

The invention will in the following be described in more detail with reference to enclosed drawings, wherein:

FIG. 1 shows a signalling scheme of a prior art method for transmitting data packets from a mobile station to a base station system when the mobile station is in idle mode.

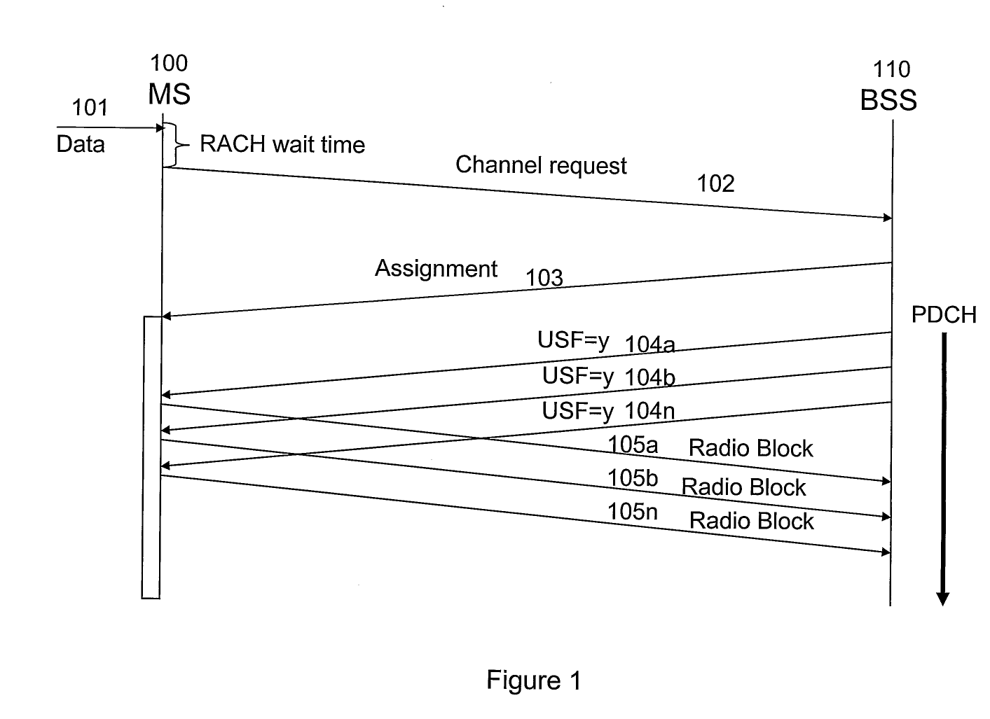

FIG. 2 shows a signalling scheme of a prior art method for transmitting data packets from a base station system to a mobile station when the mobile station is in idle mode.

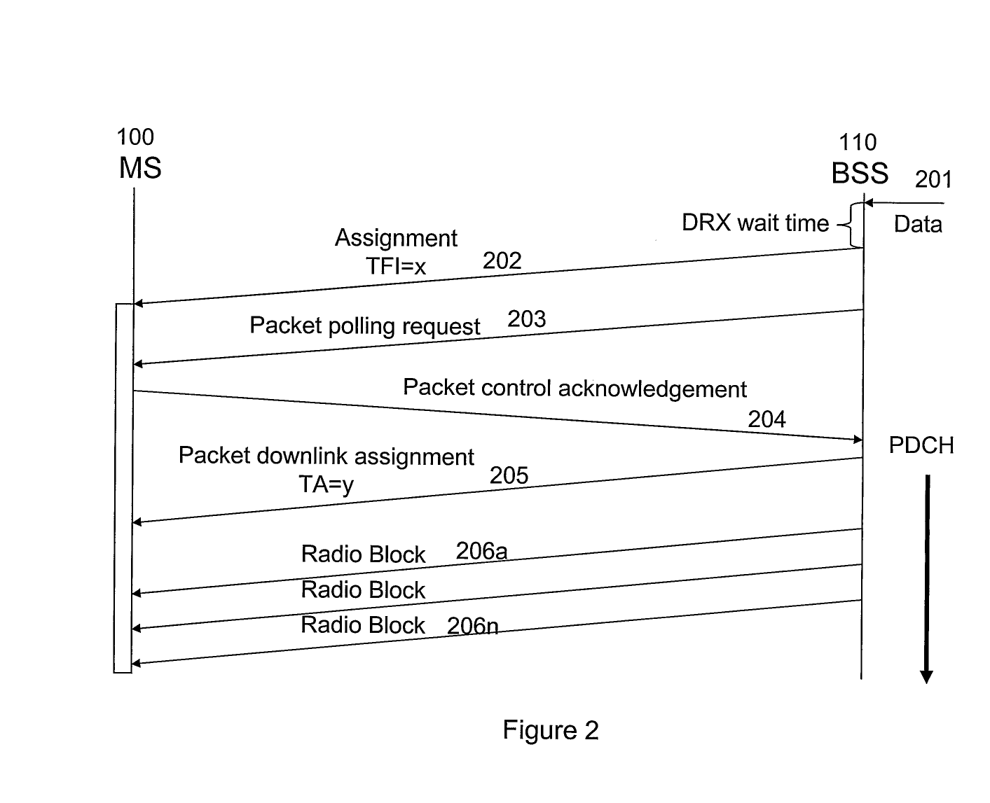

FIG. 3 shows a signalling scheme of a prior art method for transmitting data packets from a mobile station to a base station system when the mobile station is in active mode.

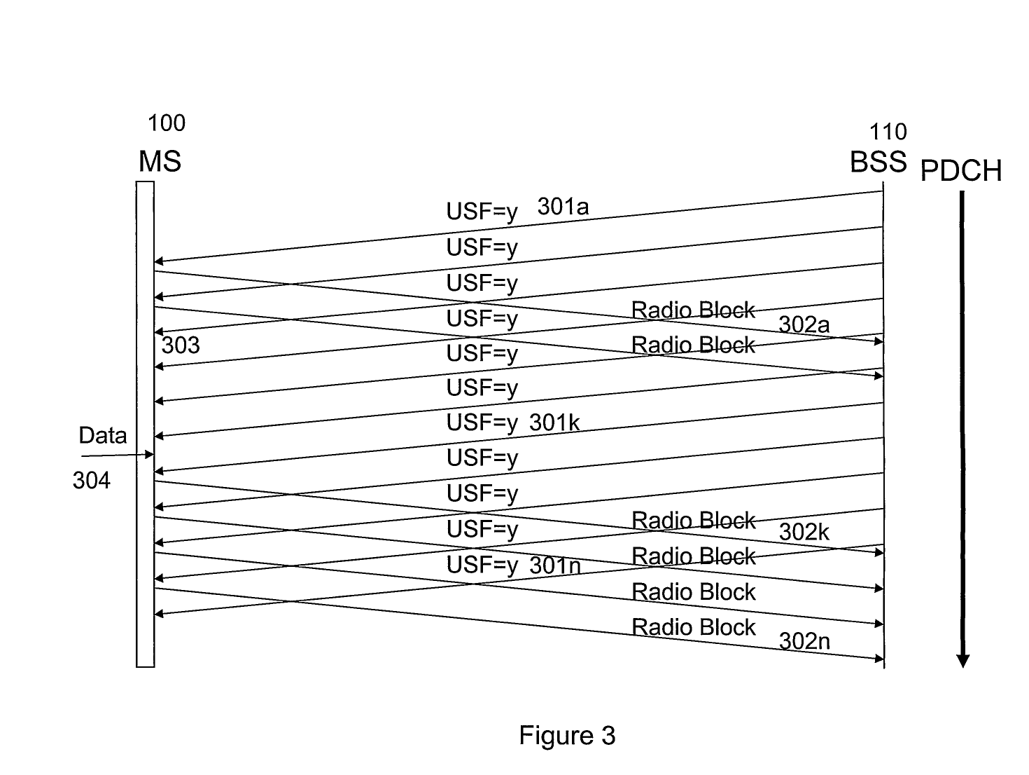

FIG. 4 shows a signalling scheme of a prior art method for transmitting data packets from a base station system to a mobile station when the mobile station is in active mode.

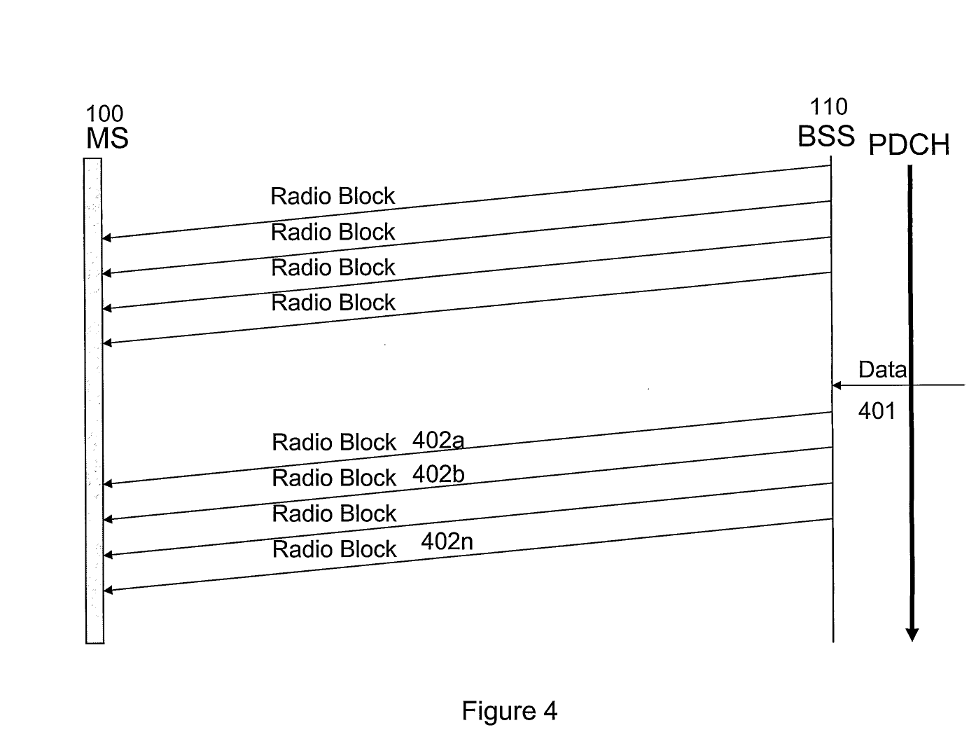

FIG. 5 shows a schematic block diagram of a mobile station and a base station system according to the present invention.

FIG. 6 shows a signalling scheme of a method according to an embodiment of the invention for transmitting data from a mobile station to a base station system.

FIG. 7 shows a signalling scheme of a method according to an embodiment of the invention for transmitting data from a base station system to a mobile station.

### DETAILED DESCRIPTION

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

According to the present invention, a first data packet is transmitted from a mobile station to a base station system, or vice versa, over a non-scheduled traffic channel that is accessible to a selected number of mobile stations residing in a cell. This non-scheduled traffic channel is a novel traffic channel that is used for transmitting data packets to or from anyone of the selected number of mobile stations without the non-scheduled traffic channel being scheduled in advance for the transmission of the first data packet between the mobile station and the base station system and without any connection being established between the mobile station and the base station system. I.e. the non-scheduled traffic channel can be used for sending data packets without any prior communication taking place over any control channel between the mobile station and the base station system. Instead, in the case of a selected mobile station wanting to transmit a data packet, the mobile station will just send the data packet directly over the non-scheduled traffic channel. The base station system will be able to detect from which mobile station the data packet originated by looking at an identifier, identifying the transmitting mobile station, appended to the transmitted data packet. In the case of the base station system wanting to send a data packet to any of the selected mobile stations it similarly sends a data packet directly over the non-scheduled traffic channel, and the selected mobile stations can look at an appended identifier, which identifies the destined mobile station, to see to which mobile station the data packet was destined.

An advantage of the invention is that the access time, i.e. the time from receiving a data packet in a buffer in the transmitting side until the data packet is transmitted is shortened compared to the prior art case when the mobile station is in idle mode. This is because the time for establishing a connection and scheduling the radio channel to be used for transmitting a data packet is avoided, a scheduling that has to be done for a mobile station in idle mode that wants to use a prior art traffic channel. Also, the access time can be shortened without unnecessary usage of system resources, as is the case when the mobile station is in the prior art active mode. Also, if the mobile station is in a discontinuous reception (DRX) mode, battery life time can be extended compared to if the mobile station would be in active mode. In this case, for downlink transmissions according to the invention, the base station system would have to wait until the mobile station would wake up to listen to the non-scheduled traffic channel until a data packet can be transmitted over the non-scheduled traffic channel.

When a plurality of data packets is received in a transmission buffer and the first data packet has been transmitted over the non-scheduled traffic channel, the data packets following the first data packet can be transmitted consecutively over the non-scheduled traffic channel.

According to an embodiment of the invention, the non-scheduled traffic channel may only be used for transmitting a first number of the plurality of data packets. According to this embodiment, a packet data channel is being scheduled to the mobile station during the transmission of the first number of data packets over the non-scheduled traffic channel. When the packet data channel has been scheduled and the connection over the packet data channel has been established, according to e.g. the prior art method of establishing a connection to/from a mobile station being in idle mode, the consecutive transmission of data packets will be switched to the scheduled packet data channel. Thereby, a second number of the plurality of data packets, preferably being the remaining data packets residing in the transmission buffer, will be transmitted over the scheduled packet data channel instead of over the non-scheduled traffic channel. By this measure, the possibility that two mobile stations belonging to the selected number of mobile stations will transmit data packets over the non-scheduled traffic channel simultaneously, with the risk of at least one of the data packets being lost, will be lowered.

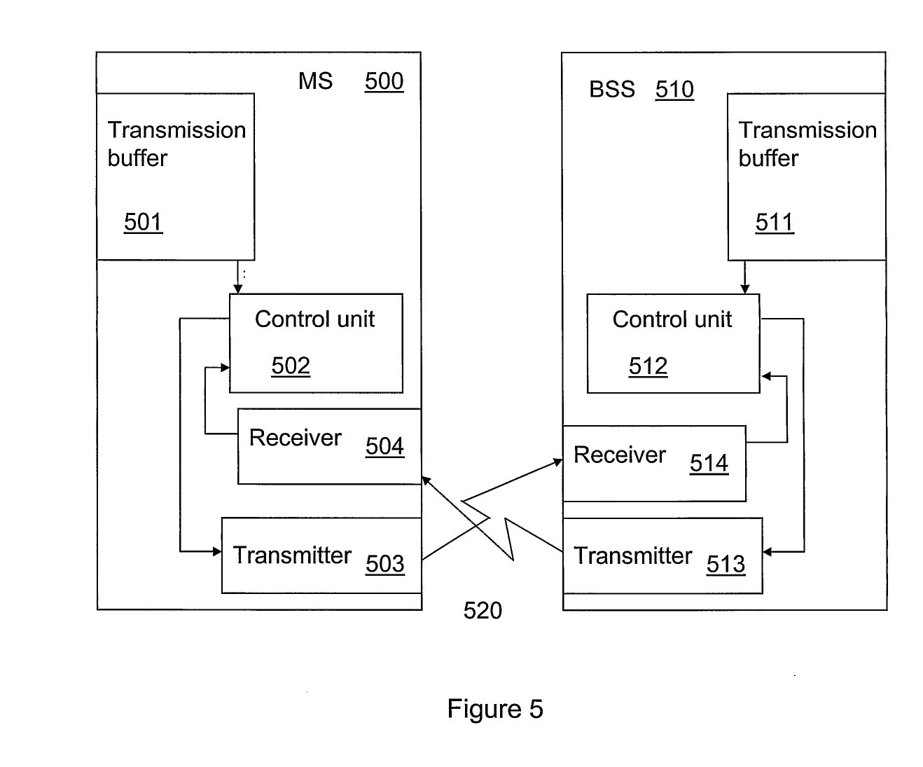

FIG. 5 shows a mobile packet data communication system according to the present invention, comprising a mobile station (MS) 500, a base station system (BSS) 510 and a radio interface 520 between the mobile station and the base station system. The base station system is built up of a base transceiver station (BTS) and a base station controller (BSC). The different units in a base station system described below may reside in either the BTS or in the BSC. The mobile station and the base station system may be used for transmitting data packets over a non-scheduled traffic channel according to the invention in the radio interface 520. The mobile station 500 comprises a transmission buffer 501 wherein data packets are received from other units in the mobile station. The data packets received in the transmission buffer are ready to be transmitted from the mobile station. The mobile station also comprises a control unit 502, a transmitter 503 and a receiver 504. The control unit is adapted to control the usage of the transmitter, e.g. to control over which radio channel a data packet is to be transmitted. Similarly, the base station system 510 comprises a transmission buffer 511 wherein data packets are received from other units in the BSS or from other nodes in the mobile communication system, and a control unit 512, a transmitter 513 and a receiver 514.

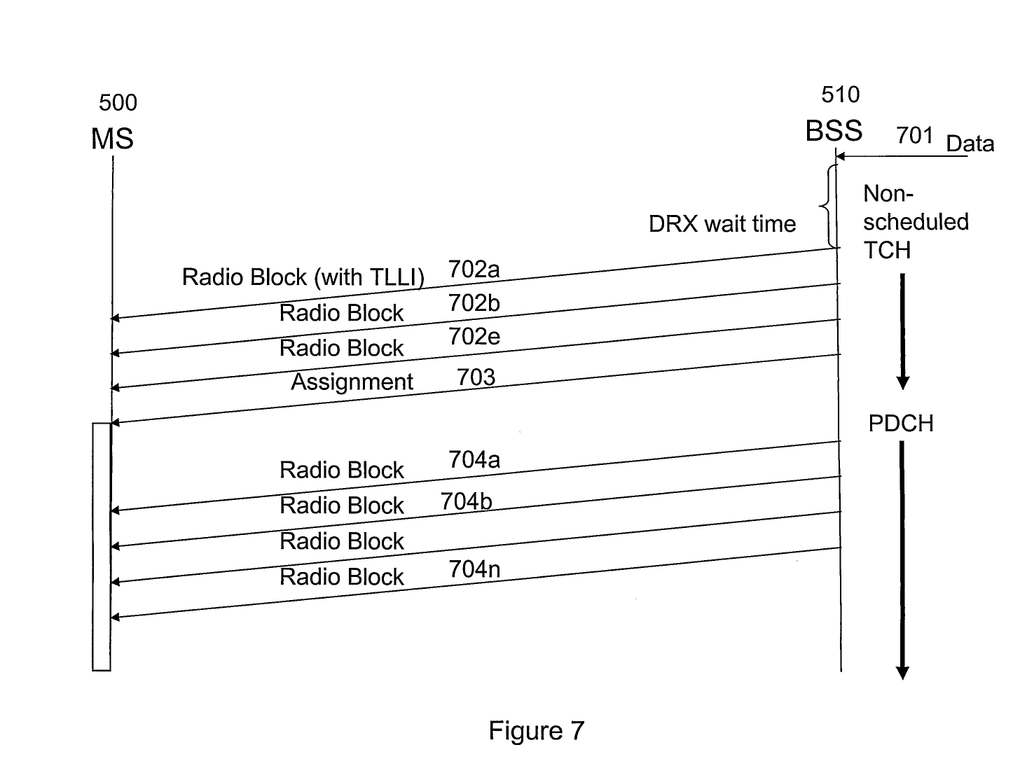

When data is to be transmitted from the MS to the BSS, a first data packet is received in the transmission buffer 501 of the MS and it is transmitted over a non-scheduled traffic channel in the radio interface 520 according to the invention. This will be achieved by the control unit 502 being adapted to instruct the transmitter 503 to transmit the first data packet over the non-scheduled traffic channel. The control unit 802 is adapted to instruct the transmitter 803 to transmit the first data packet over the non-scheduled traffic channel without the non-scheduled traffic channel being scheduled for this transmission in advance and without the mobile station having any connection established with the base station system before the first data packet is transmitted. The control unit 502 may have received its instructions from a node in the mobile communication system, via the BSS. Also, if there are a plurality of data packets situated in the transmission buffer, the control unit can be adapted to instruct the transmitter to transmit the plurality of data packets consecutively in consecutive time slots of the non-scheduled traffic channel. For the base station system 510 to be able to detect from which mobile station the first data packet that is received originated, an identifier identifying the transmitting mobile station is appended to the first data packet. Also, the receiver 514 of the base station system is adapted to listen to the non-scheduled traffic channel to detect any incoming messages. The process for transmitting data packets in the opposite direction, i.e. from the BSS to the MS would be similar, see also the description of FIG. 7 for more information.

According to an embodiment of the invention, the control unit in the mobile station 502 may be adapted to instruct the transmitter 503 to only transmit a first number of the plurality of data packets over the non-scheduled traffic channel. The rest of the plurality of data packets situated in the transmission buffer may be transmitted over an ordinary packet data channel. For this reason, a packet data channel will be scheduled, preferably during the transmission of the first number of the plurality of data packets and by the control unit 512 of the base station system 510. The control unit 512 in the BSS would be adapted to assign the scheduled packet data channel for the transmission by reserving the channel for this communication and instructing the transmitter 513 in the BSS to transmit an information message to the receiver 504 of the MS with information regarding the scheduled packet data channel. The information message is then transported from the receiver 504 to the control unit 502 of the MS and the control unit is then adapted to instruct the transmitter 503 to transmit the rest of the plurality of data packets over the scheduled packet data channel. Consequently, the non-scheduled traffic channel will be free to use for other transmissions.

If a data packet is to be transmitted from the BSS to the MS, the control unit 512 in the BSS is still adapted to decide when to use the non-scheduled traffic channel and when to use an ordinary packet data channel. Except for this, the units in the BSS are adapted to work in a similar way for downlink transmissions as the units in the MS were for uplink transmission, see also the signalling scheme of FIG. 7.

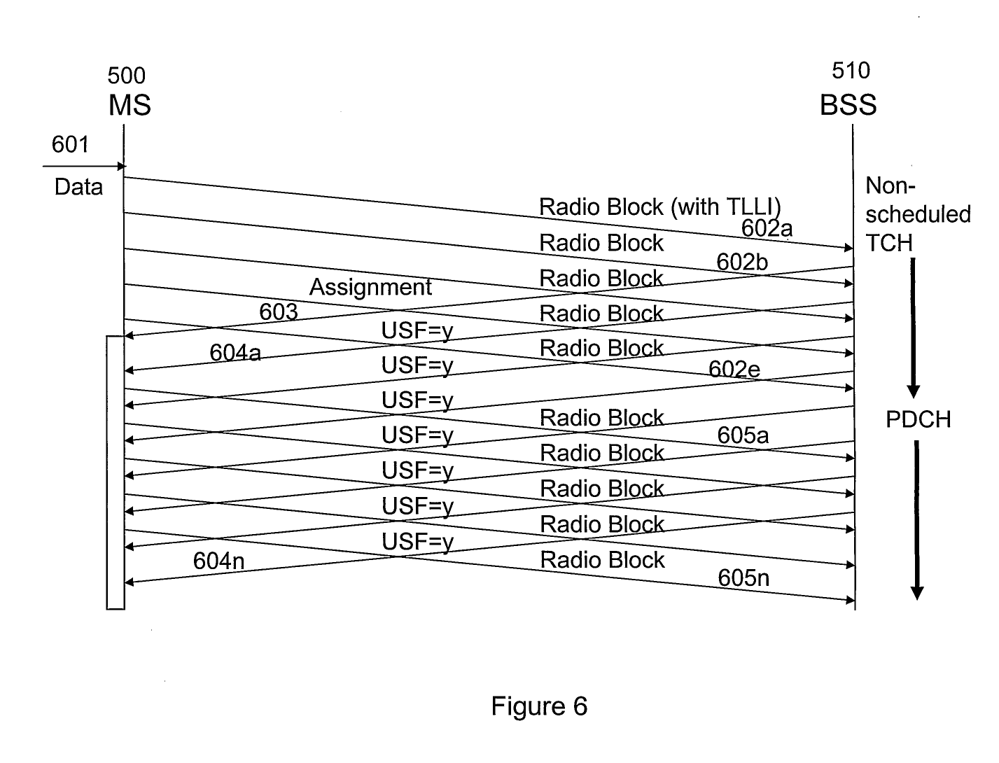

FIG. 6 shows a signalling scheme of an embodiment of the invention for transmitting data packets from a mobile station 500 to a base station system 510 in a packet data communication system based on GPRS/EDGE. A first data packet is received 601 at a transmission buffer of the mobile station 500. The first data packet is then transmitted 602a over a non-scheduled traffic channel, which is accessible for transmission for a selected number of mobile stations in a cell, as soon as the non-scheduled traffic channel can be used. The first data packet is transmitted over the non-scheduled traffic channel without using any control channels in advance to handshake between the mobile station and the base station system to use the non-scheduled traffic channel for the transmission, i.e. without scheduling the non-scheduled traffic channel in advance and without establishing any uplink Temporary Block Flow (TBF) before the first data packet is transmitted. For the base station system to know from which mobile station the first data packet was transmitted, the data packet is transmitted in a radio block comprising the data packet and also a Temporary Logical Link Identifier (TLLI) that identifies the transmitting mobile station.

Any subsequent data packets in the transmission buffer will be transmitted 602b-e in consecutive time slots over the non-scheduled traffic channel, as radio blocks, which except for the data packet will comprise the TLLI.

According to an embodiment of the invention, the packet data communication system may, during the transmission 602a-e of a first number of data packets, schedule a packet data channel (PDCH) to the mobile station. When a TBF has been established for the scheduled packet data channel, the mobile station will switch from transmitting data packets over the non-scheduled traffic channel to transmitting the not yet transmitted data packets residing in the buffer over the scheduled packet data channel. In a similar way the BSS would start listening to the scheduled PDCH. The process may be as follows: When the base station system receives the first data packet over the non-scheduled traffic channel, it will schedule a packet data channel to be used for subsequent transmission of data packets from the mobile station. The base station system sends a Packet uplink assignment message 603 to the mobile station comprising a Temporary Flow Identification (TFI) and an Uplink State Flag (USF), and possibly a Timing advance value, which assignment message informs the mobile station of the scheduled packet data channel and when to transmit over that channel. When the packet uplink assignment message is received at the mobile station, a TBF is established for the scheduled packet data channel. When the TBF is established, the mobile station will switch from transmitting over the non-scheduled traffic channel to transmitting over the scheduled packet data channel such that subsequent data packets that have not been transmitted from the mobile station will be transmitted over the scheduled packet data channel. The BSS will transmit 604a-n a message comprising a USF each time the mobile station is scheduled to transmit a data packet over the scheduled PDCH, and the mobile station will respond by transmitting 605a-n a radio block comprising a subsequent data packet over the scheduled PDCH, as long as there are data packets in the transmission buffer to transmit. If there are no more data packets to transmit from the mobile station, the TBF will be released after a certain time of no usage.

FIG. 7 shows a signalling scheme of an embodiment of the invention for transmitting data packets from a base station system 510 to a mobile station 500 in a packet data communication system based on GPRS/EDGE. A first data packet is received 701 at a transmission buffer of the base station system 510. The mobile station may, according to an embodiment of the invention, be in a DRX (sleep) mode to save battery resources, which means that it only wakes up at certain occasions to listen to certain radio channels. According to this embodiment, the MS would wake up with a certain periodicity to listen to the non-scheduled traffic channel. The MS may be configured to wake up once in a paging cycle, or it may be configured to wake up with another time period, for example more often.

After receiving the first data packet in its transmission buffer, the BSS would wait for the mobile station to wake up and listen to the non-scheduled traffic channel, if the mobile station is in sleep mode, before the BSS transmits 702a the first data packet over the non-scheduled traffic channel. The first data packet is transmitted over the non-scheduled traffic channel without any previous communication over any control channels between the mobile station and the base station system, i.e. without scheduling the non-scheduled traffic channel for the transmission and without establishing a downlink Temporary Block Flow (TBF) before the first data packet is transmitted. For the selected number of mobile stations in the cell to know to which mobile station the first data packet is destined, the data packet is transmitted in a radio block comprising the data packet and also a Temporary Logical Link Identifier (TLLI), identifying the packet and to which MS it is destined.

According to another embodiment of the invention the mobile station would not be in a DRX mode but would listen to the non-scheduled traffic channel continuously. In this case, the base station system can start transmitting over the non-scheduled traffic channel directly.

Any subsequent data packets in the transmission buffer may be transmitted 702b-e in consecutive time slots over the non-scheduled traffic channel, as radio blocks, which except for the data packets will comprise the TLLI. Preferably, if the mobile station was in DRX mode when receiving the first data packet it will leave DRX mode such that it can receive the subsequent data packets in consecutive time slots.

According to an embodiment of the invention, the base station system may, during the transmission 702a-e of a first number of data packets, schedule a packet data channel (PDCH) to be used for transmission of subsequent data packets residing in the transmission buffer. When the scheduled packet data channel has been established, the BSS will switch from transmitting data packets over the non-scheduled traffic channel to transmitting the not yet transmitted data packets residing in the buffer over the scheduled packet data channel. In a similar way the MS would start listening to the scheduled PDCH. The process may be as follows: When the BSS receives the first data packet in its transmission buffer, it would start transmitting over the non-scheduled traffic channel. At the same time, it will schedule a PDCH for further transmissions to the mobile station. The BSS will send e.g. a packet downlink assignment message 703 to the mobile station, including information about the scheduled PDCH. When the packet downlink assignment message is received at the mobile station, a TBF is established for the scheduled packet data channel. The BSS may also send a packet polling request to the MS, and the MS may answer with a packet control acknowledgement message, in order to update access parameters such as a Timing Advance value anytime during the process, if necessary.

When the TBF is established, the BSS will switch from transmitting over the non-scheduled traffic channel to transmitting over the scheduled packet data channel such that subsequent data packets that have not yet been transmitted will be transmitted over the scheduled packet data channel. The BSS will then transmit 704a-n radio blocks at following scheduled transmit instances, each radio block comprising a subsequent data packet, as long as there are data packets in the transmission buffer to transmit. If there are no more data packets to transmit, the TBF will be released after a certain time of no usage.

Corresponding means for performing the steps according to the method of the invention may be implemented with computer program software in a mobile station and/or in a base station system, preferably in the control unit of the mobile station/base station system.

According to an embodiment of the invention, the packet data communication system may classify whether a mobile station is included in the selected number of mobile stations, for which the non-scheduled traffic channel can be accessed for transmission to/from the mobile station, based on for example whether the user of the mobile station is a prioritized subscriber to the operator of the packet data communication system. The mobile station may also be classified to belong to the selected number of mobile stations based on the communication application that the data packet is a part of, or that the latest transmitted data packet was a part of, i.e. if the latest transmitted data packet was a part of a time-sensitive communication application, the non-scheduled traffic channel should be accessible for transmission of the next data packet to be transmitted. The mobile station may also be classified to belong to the selected number of mobile stations based on a Quality of Service (QoS) profile for the user of the mobile station or the data flow, e.g. based on a priority for the QoS profile or on a specific attribute in the QoS profile, for example the attributes Traffic class or Transfer Delay or similar. A mobile communication system according to GPRS/EDGE have four different traffic classes called conversational, streaming, interactive or background, that may be used by the operator to prioritize between different traffic. The value of the attribute Transfer delay defines an upper time limit for a base station system to deliver a data packet to a mobile station. Quality of Service for GPRS/EDGE is further specified in the 3GPP TS 23.107. In the case that a mobile station has been classified by the packet data communication system, e.g. in the base station subsystem, to belong to the selected number of mobile stations, this will be communicated to the mobile station, e.g. in a separate message.

According to an alternative embodiment of the invention, the selected number of mobile stations may be all mobile stations within radio coverage of the base station. This means that according to this alternative embodiment all mobile stations may have access to the non-scheduled traffic channel. In this embodiment, the non-scheduled traffic channel is preferably only used for transmitting data packets during the time it takes to setup an ordinary packet data channel.

As should be understood there may be more than one non-scheduled traffic channel available for each cell.

According to another embodiment of the invention, it may be possible for the mobile station or the base station to indicate whether the non-scheduled traffic channel should be used or not be used for transmitting the data packets in a data flow, or whether the non-schedule traffic channel should be used only for transmitting a first number of data packets, or all data packets in a data flow.

For achieving a good communication between a mobile station a base station system over the non-scheduled traffic channel, access parameters need to be updated. Access parameters are e.g.
timing advance parameters, which are used to decide when a data packet has to be sent from the MS to arrive at the BSS at a certain time. This is dependent of how far from the BSS the MS is currently situated;
power control parameters, which are used to decide the necessary transmit power of the mobile station;
coding scheme parameters, wherein the coding scheme used is dependent on the quality of the transmission channel.

According to an embodiment of the invention, the BSS would send a message (e.g. a Packet Polling Request message) to the MS requesting measurements indicative of the access parameters, which are transmitted to the BSS in a response message (e.g. a Packet Control Acknowledgement message). The access parameters are then calculated based on the received measurements. Alternatively, the BSS may in advance have instructed the MS in an instruction message to transmit response messages comprising the measurements indicative of the access parameters according to a predefined pattern, e.g. in certain time slots. The predefined pattern may define e.g. that the measurements indicative of the access parameters should be sent periodically with a periodicity defined in the instruction message. These messages may then be transmitted over the non-scheduled traffic channel. At the time slots when these response messages are transmitted, no packet data would be transmitted uplink over the non-scheduled traffic channel.

According to another embodiment of the invention, when the mobile station is informed that it belongs to the selected number of mobile stations, and consequently is allowed to use the non-scheduled traffic channel for transmitting data packets uplink, the mobile station may also be instructed to transmit on only a part of the non-scheduled traffic channel. For this reason, the mobile station may be instructed to transmit a data packet only in any of a selected number of time slots, e.g. a data packet may be transmitted from this mobile station every second radio block period, e.g. block 1, 3, 5 etc. In a similar fashion a second mobile station may be instructed to transmit data packets on block 2, 4, 6 etc. Thereby, the possibility of two mobile stations trying to access the non-scheduled traffic channel simultaneously would be lowered.

The invention is mainly described for a GPRS/EDGE based communication system. Although, the inventive idea is sufficiently general to be applicable in any multiple access radio standard, such as OFDMA (Orthogonal Frequency Division Multiple Access) radio interface standards like IEEE 802.16 (WiMAX), Super 3G and 4G.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. Method for transmitting data packets from a mobile station to a base station system in a mobile packet data communication system, wherein the mobile station is in an area within radio communication distance of the base station system, the method comprising the steps of: receiving a first data packet in a transmission buffer of the mobile station, transmitting the first data packet from the mobile station over a non-scheduled traffic channel to the base station system, wherein the non-scheduled traffic channel is accessible for transmission of data packets to/from a selected number of mobile stations residing in an area within radio communication distance of the base station system, wherein the mobile station is included in the selected number of mobile stations and wherein the first data packet is transmitted from the mobile station over the non-scheduled traffic channel without any connection being established between the mobile station and the base station system before the first data packet is transmitted and without the non-scheduled traffic channel being scheduled for the transmission before the first data packet is transmitted.

2. Method according to claim 1, further comprising the steps of: Receiving a plurality of data packets in the transmission buffer of the mobile station; and Transmitting consecutively to the base station system, the plurality of data packets over the non-scheduled traffic channel.

3. Method according to claim 1 further comprising the steps of:
Receiving a plurality of data packets in the transmission buffer of the mobile station;
Transmitting consecutively to the base station system a first number of the plurality of data packets over the non-scheduled traffic channel;
Receiving, during transmission of the first number of the plurality of data packets over the non-scheduled traffic channel, information from the base station system regarding a packet data channel scheduled to the mobile station,
Transmitting consecutively to the base station system a second number of the plurality of data packets over the scheduled packet data channel

4. Method according to claim 3, wherein the first number of the plurality of data packets comprises the data packets that had been transmitted from the mobile station to the base station system when the information regarding the scheduled packet data channel was received in the mobile station.

5. Method for transmitting data packets from a base station system to a mobile station in a mobile packet data communication system, wherein the mobile station is in an area within radio communication distance of the base station system, the method comprising the steps of:
receiving a first data packet in a transmission buffer of the base station system,
transmitting the first data packet from the base station system over a non-scheduled traffic channel to the mobile station, wherein the non-scheduled traffic channel is accessible for transmission of data packets to/from a selected number of mobile stations residing in an area within radio communication distance of the base station system, wherein the mobile station is included in the selected number of mobile stations and wherein the first data packet is transmitted from the base station system over the non-scheduled traffic channel without any connection being established between the mobile station and the base station system before the first data packet is transmitted and without the non-scheduled traffic channel being scheduled for the transmission before the first data packet is transmitted.

6. Method according to claim 5, further comprising the steps of:
Receiving a plurality of data packets in the transmission buffer of the base station system; and
Transmitting consecutively to the mobile station, the plurality of data packets over the non-scheduled traffic channel.

7. Method according to claim 5 further comprising the steps of:
Receiving a plurality of data packets in the transmission buffer of the base station system;
Transmitting consecutively to the mobile station a first number of the plurality of data packets over the non-scheduled traffic channel;
Scheduling, in the base station system, a packet data channel to the mobile station;
Transmitting an information message to the mobile station comprising information regarding the scheduled packet data channel;
Transmitting consecutively to the mobile station a second number of the plurality of data packets over the scheduled packet data channel.

8. Method according to claim 7, wherein the first number of the plurality of data packets comprises the data packets that had been transmitted from the base station system to the mobile station when the information message was received at the mobile station.

9. Method according to claim 1, wherein the mobile station is included in the selected number of mobile stations based on a user of the mobile station being a prioritized subscriber to the operator of the packet data communication system.

10. Method according to claim 1, wherein the mobile station is included in the selected number of mobile stations based on Quality of Service information for a user of the mobile station or for a data flow that the data packets belong to.

11. Method according to claim 1, wherein the first data packet is transmitted together with an identifier that identifies the mobile station.

12. Method according to claim 1, wherein the base station system instructs the mobile station to transmit messages comprising measurements indicative of access parameters to the base station system according to a pattern defined by the base station system.

13. Method according to claim 5, wherein the mobile station is in a discontinuous reception mode when the first data packet is transmitted from the base station system to the mobile station.

14. Method according to claim 1, wherein a mobile station belonging to the selected number of mobile stations is instructed to transmit a data packet using any of a number of selected time slots of the non-scheduled traffic channel.

15. Mobile station arranged for transmitting data packets in a mobile packet data communication system to a base station system, wherein the mobile station is situated in an area within radio communication distance of the base station system, wherein the mobile station comprises:
A transmission buffer arranged for receiving a first data packet;
A transmitter arranged for transmitting the first data packet over a non-scheduled traffic channel to the base station system, wherein the non-scheduled traffic channel is accessible for transmission of data packets to/from a selected number of mobile stations residing in an area within radio communication distance of the base station system, wherein the mobile station is included in the selected number of mobile stations and wherein the transmitter is arranged to transmit the first data packet over the non-scheduled traffic channel without any connection being established between the mobile station and the base station system before the first data packet is transmitted and without the non-scheduled traffic channel being scheduled for the transmission before the first data packet is transmitted.

16. Mobile station according to claim 15, wherein the transmission buffer is further arranged for receiving a plurality of data packets, and wherein the transmitter is further arranged for transmitting consecutively to the base station system a first number of the plurality of data packets over the non-scheduled traffic channel, and wherein the mobile station further comprises:
a receiver for receiving, during transmission of the first number of the plurality of data packets, information from the base station system regarding a packet data channel scheduled to the mobile station;
and wherein the transmitter is further arranged for transmitting consecutively to the base station system a second number of the plurality of data packets over the scheduled packet data channel.

17. Mobile station according to claim 16, wherein the first number of the plurality of data packets comprises the data packets that had been transmitted from the mobile station to the base station system when the information regarding the scheduled packet data channel was received in the mobile station.

18. Mobile station according to claim 15, wherein the mobile station is included in the selected number of mobile stations based on Quality of service information for a user of the mobile station or for a data flow that the data packets belong to.

19. Mobile station according to claim 15, wherein the transmitter is arranged to transmit the first data packet together with an identifier that identifies the mobile station.

20. Mobile station according to claim 15, wherein the mobile station is arranged to be in a discontinuous reception mode when the first data packet is transmitted from the base station system to the mobile station.

21. A base station system arranged for transmitting data packets in a mobile packet data communication system to a mobile station, wherein the mobile station is situated in an area within radio communication distance of the base station system, wherein the base station system comprises:
A transmission buffer for receiving a first data packet;
A transmitter for transmitting the first data packet over a non-scheduled traffic channel to the mobile station, wherein the non-scheduled traffic channel is accessible for transmission of data packets to/from a selected number of mobile stations residing in an area within radio communication distance of the base station system, wherein the mobile station is included in the selected number of mobile stations and wherein the transmitter is further arranged to transmit the first data packet over the non-scheduled traffic channel without any connection being established between the mobile station and the base station system before the first data packet is transmitted and without the non-scheduled traffic channel being scheduled for the transmission before the first data packet is transmitted.

22. Base station system according to claim 21, wherein the transmission buffer is further arranged for receiving a plurality of data packets, and wherein the transmitter is further arranged for transmitting consecutively to the mobile station a first number of the plurality of data packets over the non-scheduled traffic channel, and wherein the base station system further comprises:
a control unit for scheduling a packet data channel to the mobile station, and
wherein the transmitter is further arranged for transmitting an information message to the mobile station comprising information regarding the scheduled packet data channel, and for transmitting consecutively to the mobile station a second number of the plurality of data packets over the scheduled packet data channel.

23. Base station system according to claim 22, wherein the first number of the plurality of data packets comprises the data packets that had been transmitted from the base station system to the mobile station when the information message was received at the mobile station.

24. Base station system according to claim 21, wherein the transmitter is arranged to transmit the first data packet together with an identifier that identifies the mobile station.

25. Base station system according to claim 21, wherein the base station system is adapted to instruct the mobile station to transmit messages comprising measurements indicative of access parameters to the base station system according to a pattern defined by the base station system.

26. A computer program product loadable into a memory of a digital computer device residing in a mobile station for transmitting data packets in a mobile packet data communication system, wherein the computer program product comprises software code portions for performing the method of claim 1 when the computer program product is run on the computer device.

27. A computer program product loadable into a memory of a digital computer device residing in a base station system for transmitting data packets in a mobile packet data communication system, wherein the computer program product comprises software code portions for performing the method of claim 1 when the computer program product is run on the computer device.
